(19) United States
(12) Patent Application Publication
(10) Pub. No.: US 2013/0064136 A1
(43) Pub. Date: Mar. 14, 2013

(54) SYSTEM, DEVICE AND METHOD FOR IMPLEMENTING A PHOTOVOLTAIC-BASED COMMUNICATIONS NETWORK

(71) Applicant: Costa APOSTOLAKIS, Locust Grove, VA (US)

(72) Inventor: Costa APOSTOLAKIS, Locust Grove, VA (US)

(73) Assignee: NEXGRID, LLC, Locust Grove, VA (US)

(21) Appl. No.: 13/612,006

(22) Filed: Sep. 12, 2012

Related U.S. Application Data
(60) Provisional application No. 61/534,430, filed on Sep. 14, 2011.

(51) Int. Cl. H04W 84/18; H04W 52/02

(52) U.S. Cl. 370/254; 370/311

(57) ABSTRACT

An apparatus, system and method are provided to deliver enhanced wireless mesh networking. According to some embodiments the system is designed to enable photovoltaic-based meshed networking, which may include a networking gateway connected to a photovoltaic receptor, where the networking gateway has one or more wireless communication chips; a network device setup to be in wireless communication with multiple networking gateways, to enable a local communications network, where the network device has a Wi-Fi communication link to enable wireless communications between multiple network devices; and a communications link for connecting the network device to a non-local communications network.

### CROSS REFERENCE TO RELATED APPLICATION

This application claims priority from U.S. Provisional Patent Application No. 61/534,430, filed 14 Sep. 2011, entitled “PHOTOVOLTAIC COMMUNICATIONS NETWORK”, which is incorporated in its entirety herein by reference.

### FIELD OF THE INVENTION

The present invention relates to methods and devices useful in communicating data. Specifically, embodiments of the present invention relate to systems, methods and apparatuses that provide data communications using photovoltaic elements.

### BACKGROUND OF THE INVENTION

A wireless mesh network (WMN) is a communications network made up of radio nodes organized in a mesh topology. Wireless mesh networks often consist of mesh clients, mesh routers and gateways. The coverage area of the radio nodes working as a single network is sometimes called a mesh cloud. Access to this mesh cloud may be dependent on the radio nodes working in harmony with each other to create a radio network.

A mesh network is reliable and offers redundancy. When one node can no longer operate, the rest of the nodes can still communicate with each other, directly or through one or more intermediate nodes.

In some cases however, reliance on clients, routers and gateway may be problematic as they may be relocated, moved etc. It would be highly advantageous to have a wireless mesh network where clients, routers and/or gateways can be geographically optimized so as to provide enhanced reliability, bandwidth, and redundancy.

### SUMMARY OF THE INVENTION

There is provided, in accordance with an embodiment of the present invention, an apparatus, system, and method for enhanced wireless mesh networking. According to some embodiments of the present invention, a system for enabling photovoltaic based meshed networking, which may include a networking gateway connected to a photovoltaic receptor, where the networking gateway has one or more wireless communication chips; a network device setup to be in wireless communication with multiple networking gateways, to enable a local communications network, where the network device has a Wi-Fi communication link to enable wireless communications between multiple network devices; and a communications link for connecting the network device to a non-local communications network.

According to some embodiments, there is provided a mixed mesh networking gateway device, comprising a power supply; an antenna connector; a low power wireless communications transceiver; a Wifi communications transceiver; and a photocell male connector for enabling rapid coupling to a photovoltaic receptacle.

According to some embodiments, a mixed mesh network is provided, which may include a communications gateway device having a Zigbee transceiver; and a network device having a Zigbee transceiver and a Wi-Fi transceiver, wherein the network device communicates with multiple communications gateway devices and other networking devices to form a mixed mesh network; wherein at least some of the communications gateway devices are located on photovoltaic receptors.

According to some embodiments, a method is provided for enabling mesh networking, including connecting a networking gateway to a photovoltaic receptacle unit; powering up the networking gateway using the receptacle unit power supply; establishing a wireless communications network between a networking device and one or more networking gateways; and establishing a communications channel between the networking device and a non local communications network.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of a communications network incorporating photovoltaic communications gateways, according to some embodiments;

FIGS. 2A-2B are diagrams illustrating a photovoltaic communications gateway connected to a street light, according to some embodiments;

FIGS. 3A-3E are graphical illustrations of the components of a photovoltaic communications gateway, according to some embodiments;

FIGS. 4A-4B are further graphical illustrations of the components of a photovoltaic communications gateway, according to some embodiments;

FIGS. 5A-5G are graphic illustrations showing examples of a photovoltaic communications gateway, from several views, in accordance with some embodiments; and

FIG. 6 is a flowchart illustrating an example of a process of setting up/installing a photovoltaic communications network, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The word “photovoltaic (PV)” as used herein may encompass various photocells, solar cells or other solid state electrical devices that convert the energy of light directly into electricity. The term “communications network” as used herein may encompass a collection of terminals, links and nodes which connect together to enable telecommunication between users of the terminals.

Embodiments of the present invention enable setting up of a wireless mesh communications network, created by connecting multiple communications Gateways located on arbitrary end point devices, wherein at least some of the end point devices mount on photovoltaic receptacles, for example, mounted on street lights or other target destinations.

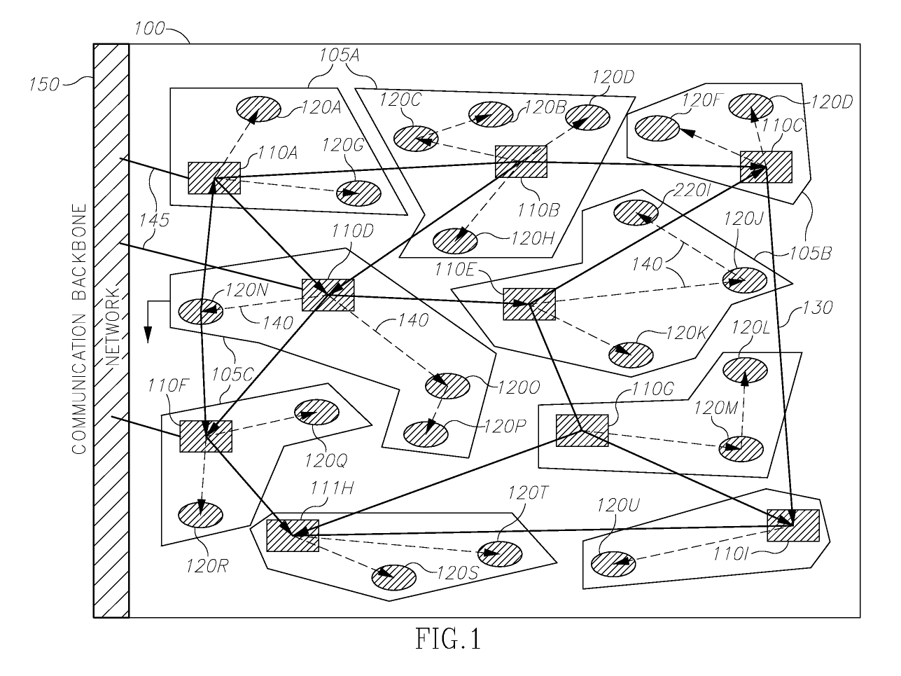

Reference is now made to FIG. 1, which is a schematic block diagram illustration of a communications network incorporating photovoltaic receptacle-mounted communications gateways. As can be seen in FIG. 1, communications network 100 is comprised of multiple end point devices that function as communications gateways 120A-N, where at least some of these gateways are coupled to photovoltaic (PV) receptacles, and are hereinafter referred to as photovoltaic communications gateways. Gateways 120 may form a local communications network or communications cell 105A-N with other gateway devices, end point devices and/or network devices 110A-N, wherein network device 110 may become a central, head or leader networking device in such a communications cell.

In some embodiments networking device 110 may also be a gateway device coupled to a PV receptacle. In some embodiments wireless mesh networking is enabled, for example by incorporating end point devices equipped with 802.15.4 (ZigBee) radios, 802.11 radios (or other related protocols such as 802.15 and 802.16), or Ethernet (802.3) capabilities etc. In some embodiments, communications network 100 may be a Mixed Mesh Network, which enables messages or data to be exchanged over a smart grid network without regard for whether the communication utilizes Wi-Fi, ZigBee or other communication protocols. Each communications gateway 120 may typically be set up at selected geographical points in the network 100 to enable substantially sufficient points to facilitate required network quality, stability, redundancy etc.

In the current example, straight lines 130 represent Wi-Fi communication links, and dashed lines 140 represent ZigBee links. However other communications links types or technologies may be used. As can be seen in the figure, end devices 110 and 120 may communicate with each other or with the Smart Grid network 100 by direct ZigBee communications, by hopping over Gateway devices, or by utilizing ZigBee to communicate with the Gateway devices. Gateway devices typically use Wi-Fi communication links to communicate with each other; however they may also use ZigBee communications links, or other wireless communication technologies, partially or entirely, to communicate with each other. End devices may be connected, via connection 145, to a communication backbone 150, such as a fiber optic or other wired backbone connection to a power utility's data center/Internet.

According to some embodiments, one or more end devices 110 may act as head end servers that may be the recipients of data from all the network devices and gateways. These head end servers may, for example, include a database that houses the data and presents it to web portals or integrates that data into other systems the power utility owns, such as SCADA, billing, or outage notification. In some embodiments, the wireless mesh communication algorithms may be based on open source meshing protocol(s) that is an open source library. For ZigBee communications, the meshing built into ZigBee may be used, optionally with additional proprietary logic to the ZigBee protocol(s) to provide enhanced information for management of the network, and to add security to the “handshake” process for joining the network.

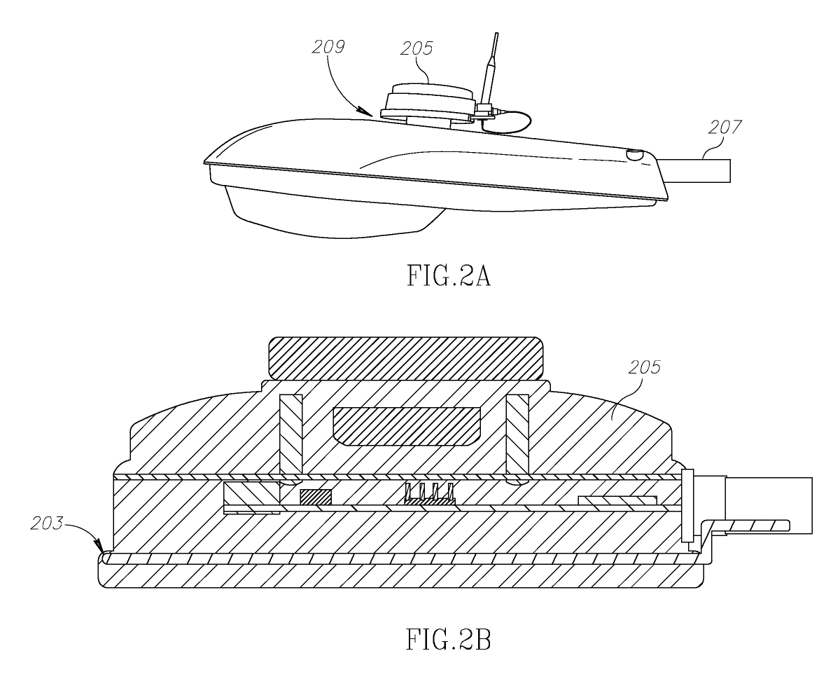

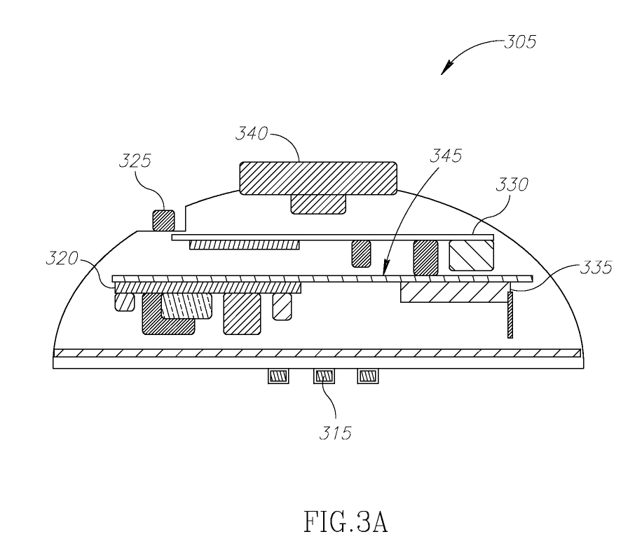

Reference is now made to FIG. 2A, which is a diagram illustrating a photovoltaic communications gateway 205 connected to a location with a PV receptor, for example street light 207, at the PV receptacle 209, according to some embodiments. Further, with reference to FIG. 2B, communications gateway 205 can be seen in schematic form with its bottom mount 204, which may be adapted to couple to PV receptacle 209.

In accordance with some embodiments, gateway devices 205 are designed to serve relatively small cells or target area, for example, to serve 30-50 homes. The communications gateway as such requires appropriate power requirements and transceiving capabilities, which in general can be constructed with hardware so as to have a mass and volume that may be readily placed on a typically street light PV receptacle 209. Since communications gateways 205 are required to support small communication cells, their reduced hardware size and power requirements may facilitate network creation where the combination of small cells and inexpensive hardware allows for significant redundancy. Further, the small size and hardware simplicity of the gateways allow for easy installation onto existing network objects or devices.

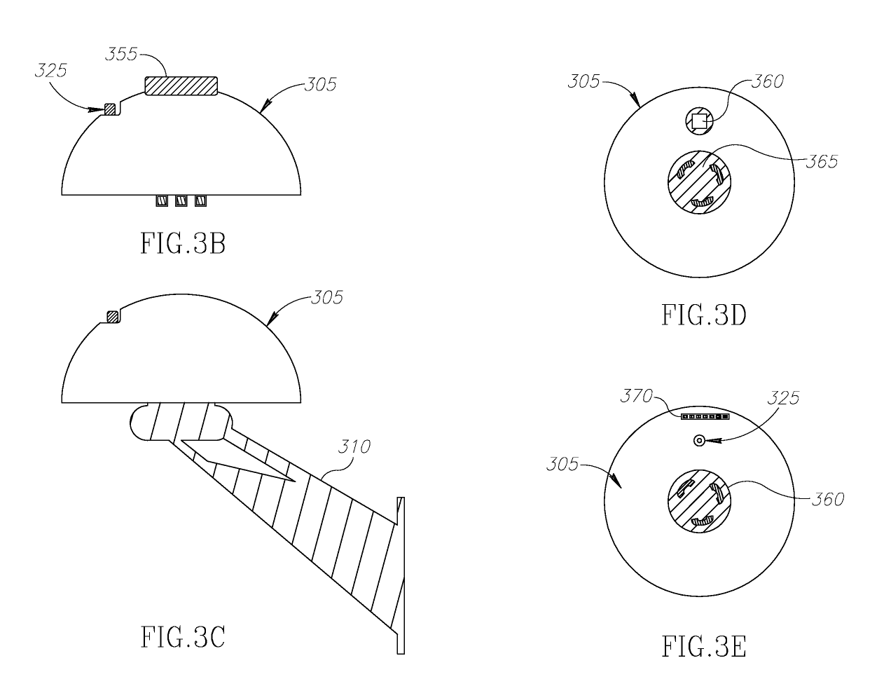

In accordance with some embodiments, gateway device 205 simply plugs or screws into standard photocell receptacles 209 that are standard on typical street lights, an/or other electric powered objects or locations. Such a gateway may power up from the street light power source, using the PV receptacle on the street light, and therefore such a device enables rapid and easy installation using common existing infrastructure. The photocell receptacle male end, or plug in (see below in FIG. 3A), may also act as the mount for the gateway device, thereby obviating the need for any screws or nails or other fasteners. Further, in some embodiments, the gateway device 205 may include an integrated photocell or an additional PV receptacle into which an external photocell unit may be setup. Such an integrated or external PV cell may be used to power the gateway device and/or the streetlight. In other embodiments other internal or external energy sources may be used to generate power that may be used, partially or wholly, to power the gateway. In some embodiments the integrated or external photocell may be used as a backup in case the gateway cannot connect to other gateway devices, networking devices, or other relevant system components.

According to some embodiments, the street light communications gateway may provide a central link between endpoint devices and a power utility's mission-critical systems, enabling intelligent network control and monitoring. In some implementations, a sophisticated Mesh communication technology provides ubiquitous coverage throughout the network at a low cost, for example, facilitating network creation supporting Ethernet (RJ45), ZigBee (802.15.4) and WIFI (802.11.N). The gateways' ability to mix and match the different systems to achieve maximum efficiency in the network provides a scalable broadband infrastructure that features robust security to ensure full regulatory compliance and network safety. The gateways may further provide highly-reliable connections to end point products including electricity, water, and gas meters over a secure infrastructure. Further, gateways can communicate with third party devices to create a platform for Demand Side Management, Smart Home, and other Utility asset devices that require communication.

Reference is now made to FIGS. 3A-E, which illustrate some of the gateway components and configuration elements, according to some embodiments. Communications gateway 305, herein also referred to as a Smart Grid Gateway, may enable mounting on street light pole mount 310 (in FIG. 3C) or other photocell mounts, to allow such a street light apparatus to become part of a data communications network. Further features enabled by the simple setup and configuration of the gateways may enable plug-in powering (i.e. tapping into the the power grid that is powering the gateway) using the photocell mount or receptacle. Such a communications network may be designed, in some embodiments, to enable dynamic provisioning and self-healing using MESH wireless network properties. In further embodiments, such a communications network may provide full security provision including Advanced Encryption Standard (AES) and Data Encryption Standard (DES) support. In further embodiments, gateways may also be updated or maintained using over the air (OTA) firmware update support.

As can be seen in FIG. 3A, the gateway device 305 may include a photocell male connector 315, to enable click-in coupling to a street light female photocell receptacle (not shown). Gateway device 305 may have an independent power supply 320, to provide alternative or back up power for the device. Gateway device 305 may include an antenna receptacle or connector 325, for example tier enabling plugging in an SMA-based antenna or other suitable antenna. Gateway device 305 may include an 802.11 transceiver 330 for enabling Will communications, and a ZigBee transceiver 335. Gateway device 305 may have a photocell female connector 340, to enable click in coupling of an external PV device into gateway device 305. Such an external PV device may be used to power street light and/or the gateway device.

FIGS. 3B-3E illustrate some additional gateway device components. Gateway device 305 may include, for example, an SMA antenna 325, and ANSI female connector 355, a resistor 360, such as an RJ45 PGE resistor, an ANSI male connector 365, as well as LED(s) or LED panel 370, for example, to indicate operation activity. Of course, other elements or combinations of elements may be used.

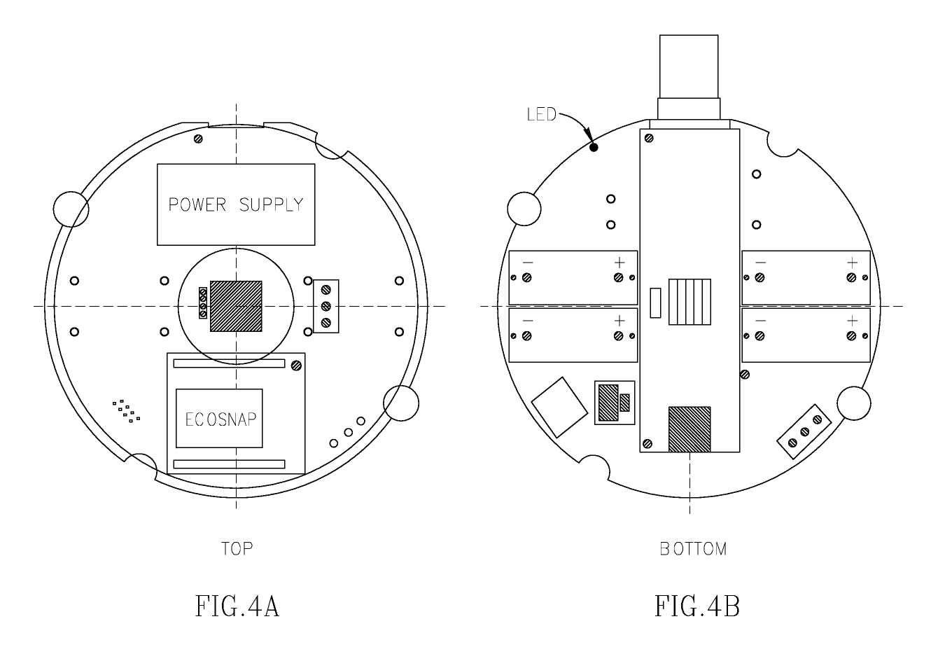

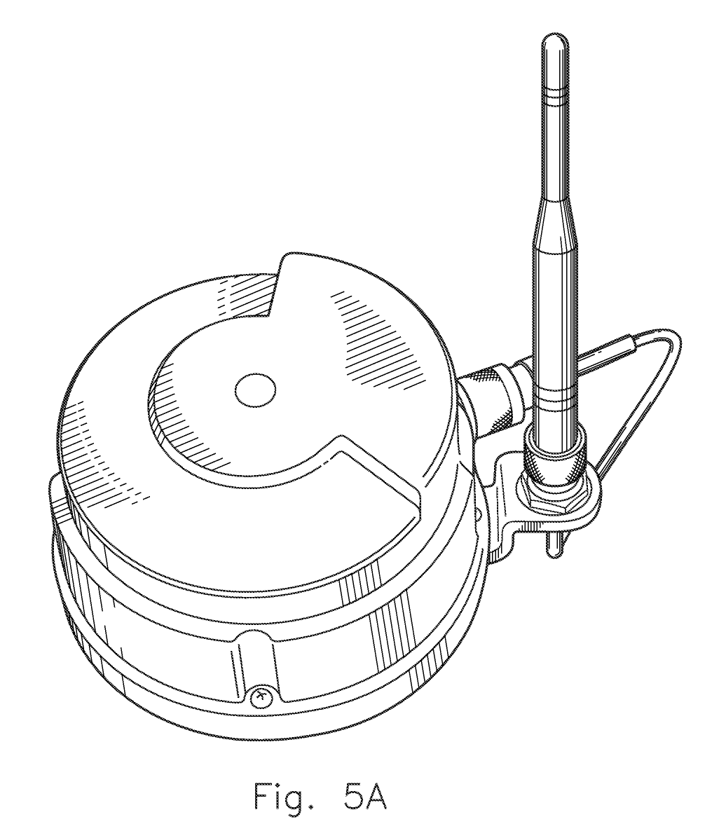

Reference is now made to FIGS. 4A and 4B, which provide graphic illustrations of an example of the gateway from top and bottom views of the gateway device respectively, according to some embodiments.

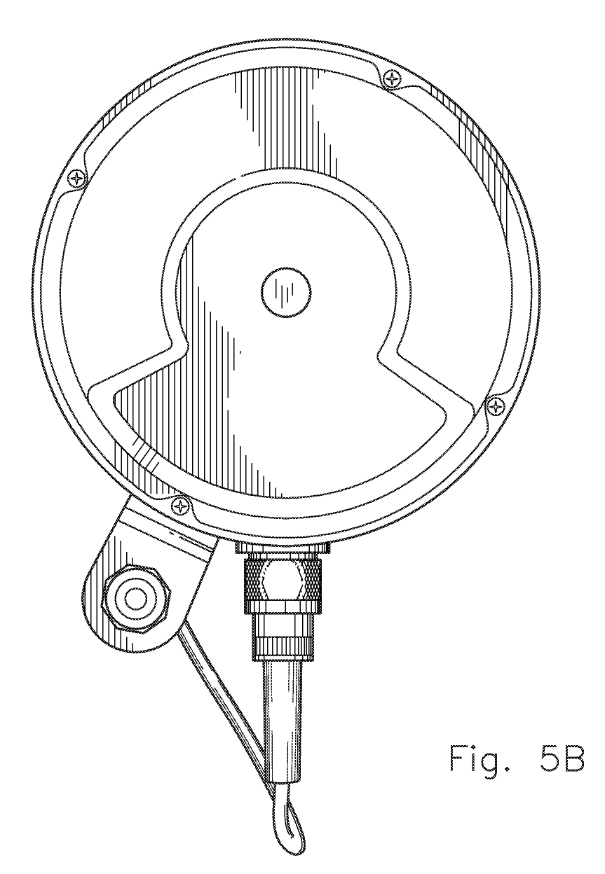

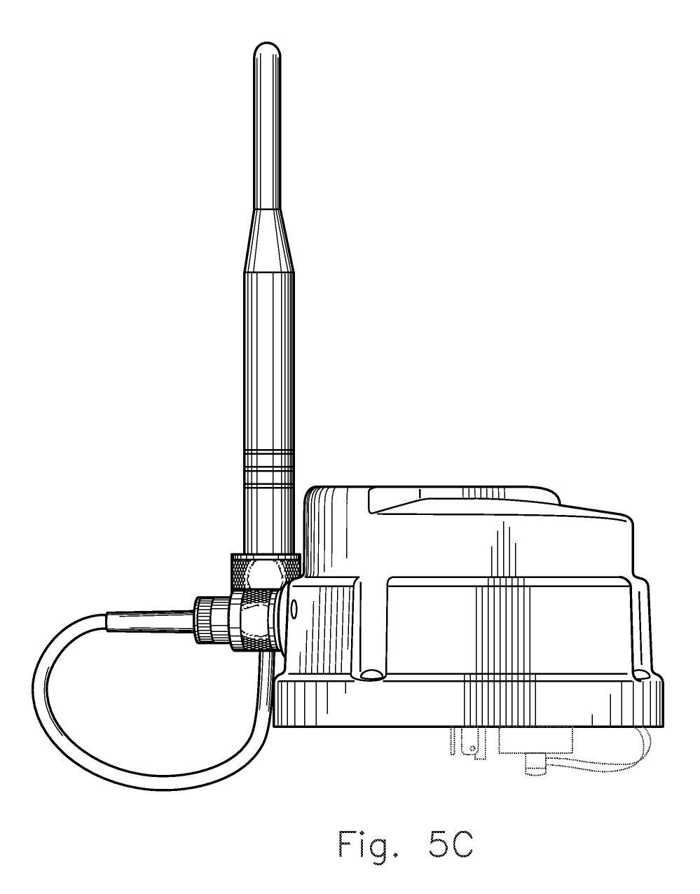

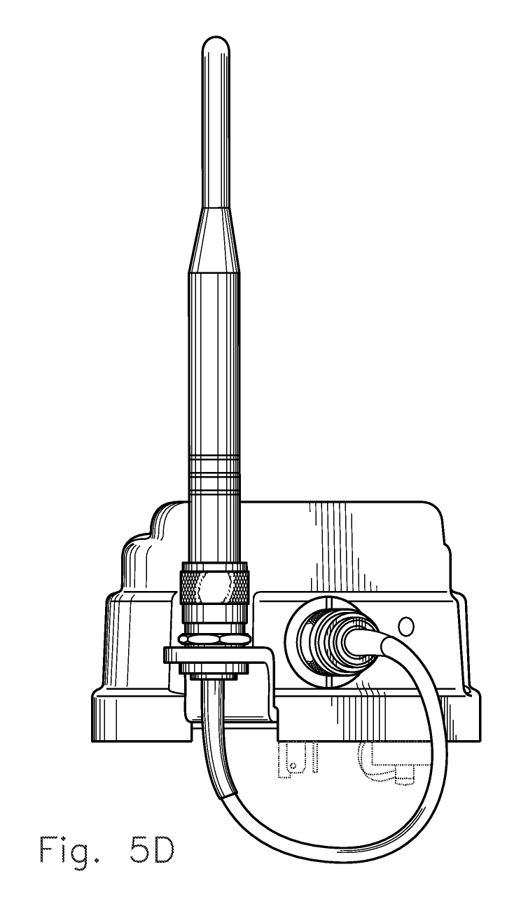

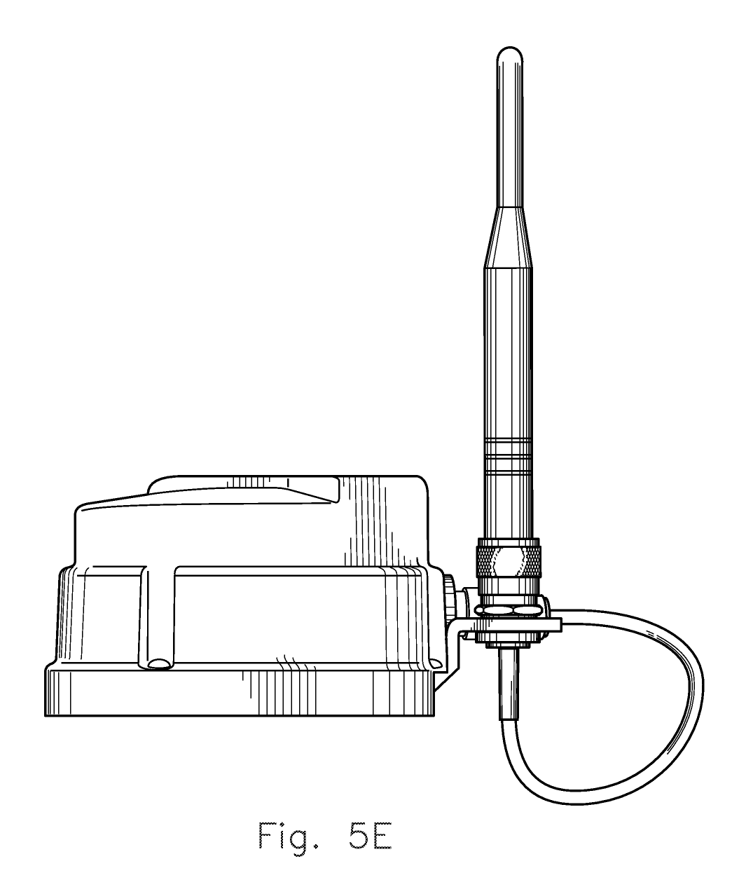

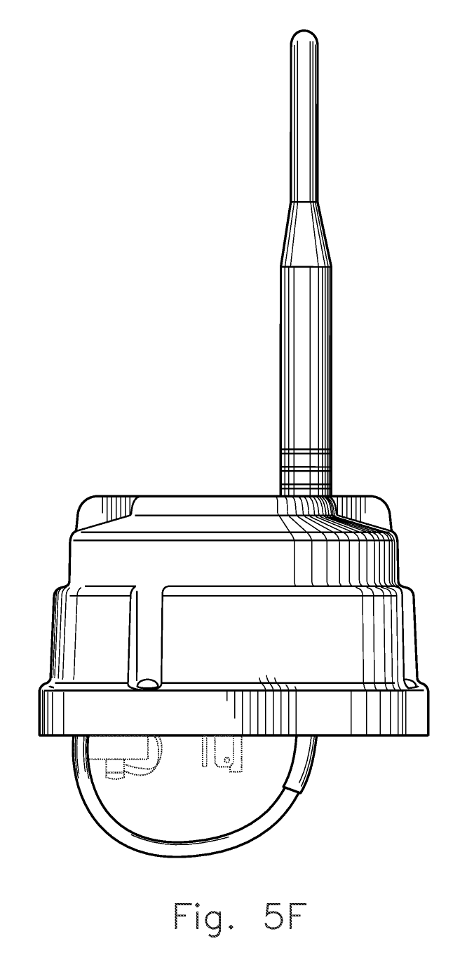

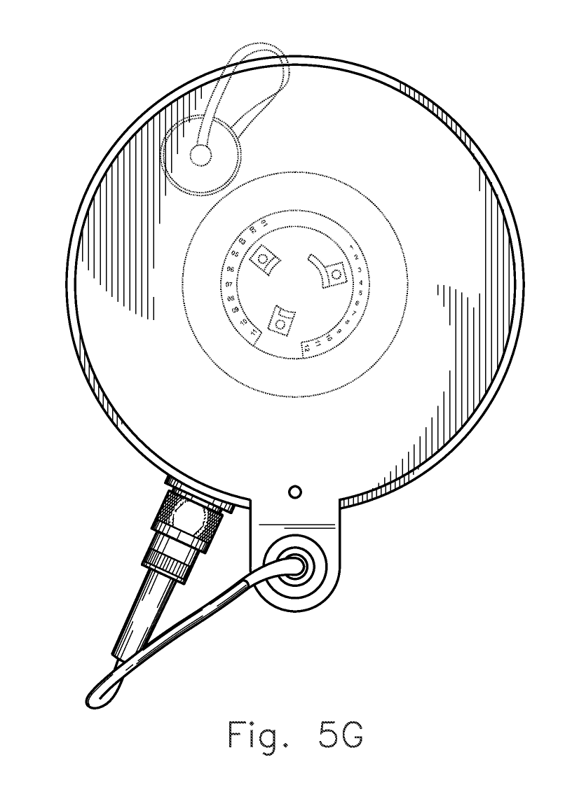

FIGS. 5A-5G are graphic illustrations showing examples of a photovoltaic communications gateway, from several views, in accordance with some embodiments. FIG. 5A is a perspective view of a wireless communications gateway. FIG. 5B is a top plan view of the wireless communications gateway. FIG. 5C is left-side of the wireless communications gateway. FIG. 5D is a rear view of the wireless communications. FIG. 5E shows the right-side of the wireless communications gateway. FIG. 5F is a front view of the wireless communications gateway. FIG. 5G is a bottom plan view of the wireless communications gateway. Of course, other formats, sizes, shapes, materials, elements and configurations may be used.

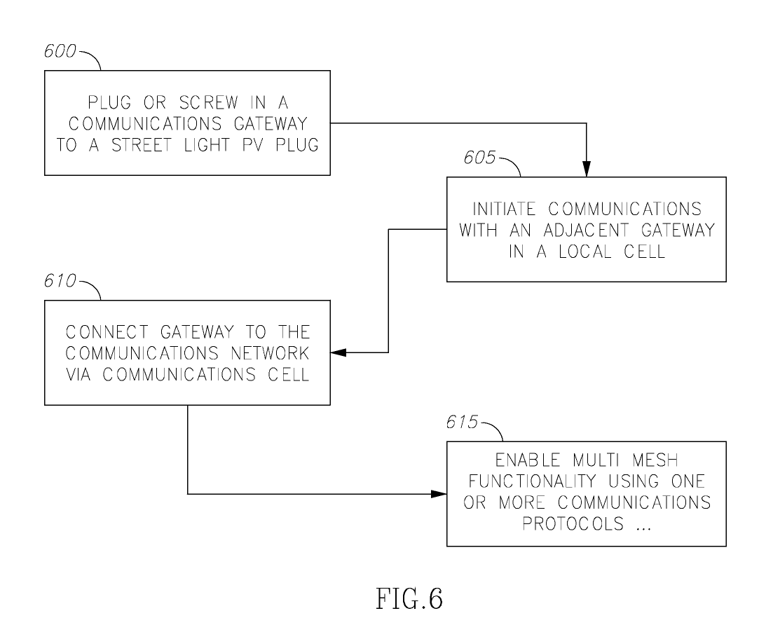

Reference is now made to FIG. 6, which is a flow chart describing a series of steps to enable meshed wireless networking in a smart grid network, using at least some photovoltaic communications gateways, according to some embodiments. At block 600, an installer or operator may plug or screw in a Communications Gateway to a street light PV plug. For example, using a typical PV mount or receptacle, the Gateway may be rapidly plugged in or screwed on and secured, and may be automatically connected to the street lights power electric supply without any further need for manually connecting the gateways to an energy source. In some embodiments, a photovoltaic or solar power unit may be coupled to the Communications Gateway, or may be integrated into the Communications Gateway.

At block 605 the gateway may be turned on to thereby initiate wireless communications with an adjacent gateway or end device in a local communications cell. At block 610 the installed Gateway may be communicatively connected to the Communications network, such as a smart grid network, via a local communications cell, which may or may not be a PV mounted communications gateway. At block 615 the gateway initiates multi mesh communication functionality using one or more communications protocols. For example, ZigBee, Wi-Fi or ZigBee/Wi-Fi communication protocols may be used to transmit data through the communications network. Other steps, orders of steps or combinations of steps may be used. Any combination of the above steps may be implemented. Further, other steps or series of steps may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling photovoltaic based meshed networking, comprising:
a networking gateway connected to a photovoltaic receptor, said networking gateway having one or more wireless communication chips; and
a network device setup to be in wireless communication with a multiple of said networking gateways, said network device having a wireless communication link to enable wireless communications between multiple network devices;
wherein said networking gateway is adapted to enable mesh networking.

2. The system of claim 1, wherein said network device in conjunction with said one or more of said networking gateways forms a communications cell, and wherein said network device is connected to a communication backbone.

3. The system of claim 1, wherein said networking device is designed to be implemented in a Smart Grid Network.

4. The system of claim 1, wherein said meshed networking includes mixed-mesh networking.

5. The system of claim 1, wherein said network device is a networking gateway.

6. The system of claim 1, wherein said networking gateway has a female photovoltaic receptacle for attachment of an external photovoltaic device onto the gateway.

7. The system of claim 1, wherein said photovoltaic receptor is located on a street light.

8. A wireless mesh photovoltaic networking gateway device, comprising:
a power supply;
an antenna connector;
a low power wireless communications transceiver;
a Wifi communications transceiver; and
a photocell male connector for enabling rapid coupling to a photovoltaic receptacle.

9. The networking gateway device of claim 8, further comprising a photocell female connector.

10. The networking gateway device of claim 8, wherein said low power wireless communications transceiver is a Zigbee transceiver.

11. A mixed mesh network, comprising:
a communications gateway device having a low power wireless communications transceiver; and
a networking device having a low power wireless communications transceiver and a Wi-Fi transceiver, wherein said networking device communicates with multiple communications gateway devices and other networking devices to enable mixed mesh networking;
wherein at least some of said communications gateway devices are coupled to a photovoltaic receptor.

12. The mixed mesh network of claim 11, wherein said photovoltaic receptor is located on a street light.

13. The mixed mesh network of claim 11, wherein said gateway devices are set up at substantially sufficient points to facilitate network communications quality.

14. The mixed mesh network of claim 11, wherein said gateway devices are set up at sufficient points to facilitate network communications stability.

15. The mixed mesh network of claim 11, wherein said gateway devices are set up at sufficient points to facilitate network communications redundancy.

16. The mixed mesh network of claim 11, wherein said low power wireless communications transceiver is a Zigbee transceiver.
